(19) United States
(12) Patent Application Publication
(10) Pub. No.: US 2009/0143494 A1
(43) Pub. Date: Jun. 4, 2009

(54) Flame Retardant Additive Compositions and Use Thereof

(75) Inventors: Arthur G. Mack, Prairieville, LA (US); Hoover B. Chew, Prairieville, LA (US)

Correspondence Address: ALBEMARLE CORPORATION, 451 FLORIDA STREET, BATON ROUGE, LA, 70801-1765, US

(73) Assignee: ALBEMARLE CORPORATION, Baton Rouge, LA (US)

(21) Appl. No.: 12/293,496

(22) PCT Filed: Apr. 3, 2007
(86) PCT No.: PCT/US07/65879

§ 371 Date: Sep. 18, 2008

Related U.S. Application Data
(60) Provisional application No. 60/790,452, filed on Apr. 6, 2006.

(51) Int. Cl. C09K 21/14; C08J 9/02; C09K 3/00

(52) U.S. Cl. 521/107; 524/710; 252/182.3

(57) ABSTRACT

Improved flame retardant additives are formed from (A) at least one bis(alkanoic acid ester) of a ring-brominated aromatic diester diol; (B) liquid alkylated triphenyl phosphate having an approximate average formula (RₓPhO)₃P═O) in which each R is, independently, a hydrogen atom or a C₁₄ alkyl group and x is an average number in the range of about 0.2 to 3; and (C) at least one alicyclic phosphonate ester having 1, 2 or 3 phosphorus atoms in the molecule, at least one of which is part of an alicyclic ring system, and having a phosphorus content of at least about 15 wt %. Combinations of these components are well-suited for use in various polymers or resins, especially polyurethanes.

### TECHNICAL FIELD

This invention relates to novel additive mixtures which are well-suited for use as flame retardants and to their use in various polymers or resins, especially polyurethanes.

### BACKGROUND

Heretofore, certain mixtures of bromine and phosphorus flame retardants have been described for use in various specified polymeric substrates. See for example, U.S. Pat. Nos. 4,746,682; 4,892,892; 5,164,417; and 5,728,760. While effective, a need exists for new flame retardant additives which are not only effective as flame retardants but which have other desirable properties such as good storage stability, as well as desirable consistency and viscosity. In the case of flexible polyurethane foams, desirable properties also include the ability to provide scorch resistance and the capability of satisfying industrial test standards such as the California 117 Test Procedure as set forth in Technical Bulletin 117 dated March 2000 without use of excessive amounts of flame retardant in the polyurethane.

### BRIEF SUMMARY OF THE INVENTION

In one of its embodiments, this invention provides new effective flame retardant additive compositions for use in various polymers or resins. Such compositions comprise a liquid mixture formed from at least the following components:
A) at least one bis(alkanoic acid ester) of a ring-brominated aromatic diester diol;
B) liquid alkylated triphenyl phosphate having an approximate average formula (RₓPhO)₃P═O) in which each R is, independently, a hydrogen atom or an alkyl group having in the range of 1 to 4 carbon atoms and x is an average number in the range of about 0.2 to 3; and
C) at least one alicyclic phosphonate ester having 1, 2 or 3 phosphorus atoms in the molecule, at least one of which is part of an alicyclic ring system, and having a phosphorus content of at least about 15 wt %.

Throughout this specification and claims, the term “component”, whether in the singular or plural, is used to denote that the substance as named is in the named chemical form prior to being used as an ingredient in making a liquid additive mixture or in making a formulation or recipe for making, say, a polyurethane. The term “component” does not denote that the component necessarily retains its original chemical form or composition when so used, as the “component” may lose its original chemical form and/or composition when so used.

Preferably the additive composition also contains at least one hindered amine antioxidant.

Polyurethane compositions of this invention have been found capable of passing the California 117 Test Procedure.

This invention also relates to the use of such mixtures as flame retardants in polymers or resins, especially polyurethanes, and more particularly in flexible polyurethane foams, high resilient polyurethane foams, or viscoelastic polyurethane foams, and to polyurethane compositions in which such additive combinations have been used or to which such additive combinations have been added.

These and other features and embodiments of this invention will become still further apparent from the ensuing description and appended claims.

### FURTHER DETAILED DESCRIPTION OF THE INVENTION

### Component A)

This substance is composed predominately of a ring-brominated aromatic diester diol in which the diol portions have been acylated by an aliphatic acylating agent such as acetic anhydride or acetyl halide. In other words, component A) is at least one bis(alkanoic acid ester) of a ring-brominated aromatic diester diol. Component A) can be represented by the formula

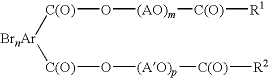

where Ar is an aryl group, preferably phenyl, Br is a bromine atom, n is in the range of 1-4 (preferably 2-4, and more preferably 4), A and A′ are, independently, C₂₋₄ alkyleneoxy groups (preferably C₂₋₃ alkyleneoxy groups, and still more preferably C₂ alkyleneoxy groups), m is in the range of 1-4 (preferably 2), p is in the range of 1-2 (preferably 1), and each of R¹ and R² is, independently, an alkyl group of 1-8 (preferably 1-4, and more preferably both R¹ and R² are the same, and still more preferably both are methyl). Various acylated brominated aromatic diester diols can be used. Typically these compounds are liquid diol esters of a bromoaromatic 1,2-dicarboxylic acid or anhydride in which the compound has 1-4, and preferably 2-4, bromine atoms per molecule, that have been acylated with an alkanoic acid anhydride (acetic anhydride, propionic anhydride, etc. up to about nonanoic anhydride), or alkanoyl halide (acetyl chloride, acetyl bromide, propionyl chloride, etc. up to about nonanoyl chloride or nonanoyl bromide).

Non-limiting examples of liquid bromoaromatic diol esters that can be acylated to form Component A) include the reaction product of 1,4-butane diol and propylene oxide with tetrabromophthalic anhydride, the reaction product of diethylene glycol and ethylene oxide with tetrabromophthalic anhydride, the reaction product of tripropylene glycol and ethylene oxide with tribromophthalic anhydride, the reaction product of 1,3-butanediol and propylene oxide with tetrabromophthalic anhydride, the reaction product of dipropylene glycol and ethylene oxide with dibromosuccinic anhydride, the reaction product of two moles of ethylene oxide with tribromophthalic anhydride and other similar compounds. The more preferred compounds of this type are liquid diol esters of polybromophthalic acid or anhydride, especially where the aromatic moiety has 4 bromine atoms. A more preferred compound is the reaction product of diethylene glycol and propylene oxide with tetrabromophthalic anhydride. Methods for manufacturing such compounds and other examples of such compounds are described for example in U.S. Pat. No. 4,564,697 issued Jan. 14, 1986 to Burton J. Sutker and entitled “Halogenated Polyol-Ester Neutralization Agent”. SAYTEX® RB-79 flame retardant (Albemarle Corporation), and PHT4-Diol (Great Lakes Chemical Corporation) represent preferred commercially available products that can be acylated to form component A).

The aliphatic acylating agent used to acylate the ring-brominated aromatic diester diol can be a carboxylic acid anhydride, RCO—O—OCR, wherein each R is an alkyl group of 1 to about 8 (preferably 1 to about 4) carbon atoms, or an acyl halide, RCOX, wherein R is an alkyl group of 1 to about 8 carbon atoms and X is a bromine or chlorine atom. Non-limiting examples include acetic anhydride, propionic anhydride, butyric anhydride, isobutyric anhydride, pentanoic anhydride, hexanoic acid, heptanoic anhydride, octanoic anhydride, nonanoic anhydride, acetyl chloride, acetyl bromide, propionyl chloride, propionyl bromide, butyryl chloride, butyryl bromide, pentanoyl chloride, pentanoyl bromide, hexanoyl chloride, hexanoyl bromide, heptanoyl chloride, heptanoyl bromide, octanoyl chloride, octanoyl bromide, nonanoyl chloride, or nonanoyl bromide. Use of acetic anhydride, acetyl chloride, or acetyl bromide is preferred.

Acylation of the ring-brominated aromatic diester diol is typically conducted at a temperature in the range of about 120 to about 140° C. The reactants are normally employed in stoichiometric proportions although a small excess of acylating agent can be used.

### Component B)

This component is a liquid alkylated triaryl phosphate ester having an approximate average formula (RₓArO)₃P═O) in which each R is, independently, a hydrogen atom or an alkyl group having in the range of 1 to 4 carbon atoms, each Ar is, independently, an aryl group, preferably a phenyl group, and x is an average number in the range of about 0.2 to 3, and preferably in the range about 1 to about 2, provided the mixture is a liquid at ordinary room temperatures, and preferably at 10° C. as well. Mixtures in which the alkyl groups are C₃ or C₄ alkyl groups are preferred, and those with C₃ alkyl groups (typically isopropyl groups) are particularly preferred. Depending on the value of x, these mixtures can amounts of unalkylated, singly alkylated, and multiply alkylated aryl (preferably phenyl) groups. The term “alkylated” does not infer that the product mixture must be formed from a reactant (e.g. a phenol) that has been alkylated. Natural products (e.g., phenols) containing suitable alkyl substituents in appropriate proportions can be used in part or in whole in preparing such product mixtures as by reaction with POCl₃. Liquid mixtures of alkylated triaryl phosphate esters which can be used in the practice of this invention are referred to, for example, in U.S. Pat. Nos. 2,960,524, 3,576,923; 4,746,682; and 5,164,417. Many suitable liquid mixtures of alkylated triaryl phosphate esters are available in the marketplace from various sources. For example, products available from Chemtura Corporation under the Reophos trademark such as Reophos® 35, 50, and 65 flame retardants, and apparently Reophos® NHP as well, and various products available from Supresta under several different trademarks such as Fyrol A710, Syn-O-Ad 9585 or 9578, Syn-O-Ad 8484 or 8475, and Phosflex 31L/41L or 71B, and other similar products serve as candidate materials. Desirably the mixture used should have a moderate viscosity, e.g., about 4000 cps or less at 25° C.

### Component C)

At least one alicyclic phosphonate ester serves as component C). These compounds have 1, 2 or 3 phosphorus atoms in the molecule, at least one of which is part of an alicyclic ring system. A preferred group of such alicyclic phosphonate esters are represented by the formula:

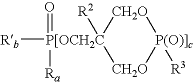

wherein a is 0, 1, or 2; b is 0, 1, or 2; c is 1, 2, or 3 and a+b+c is 3; R and R′ are the same or different and are alkyl, alkoxy, aryl, aryloxy, alkaryl, alkaryloxy, aryalkyl, aryloxyalkoxy, or aralkoxy, wherein the alkyl portion of these groups may contain hydroxyl and the aryl portion may contain one or more chlorine atoms, one or more bromine atoms, and/or one or more hydroxyl groups; R² is alkyl, hydroxyalkyl, or aryl; and R³ is alkyl having 1-4 carbon atoms.

Preferred compounds of the above formula are those in which R and R′ are the same or different and are alkyl or alkoxy which may contain hydroxyl; R² is alkyl or hydroxyalkyl; and R³ is alkyl having 1-4 carbon atoms.

Illustrative compounds of this type and methods for their preparation are described, for example, in U.S. Pat. No. 3,789,091 to Anderson, Camacho, and Kinney. Note especially Examples I, Ia, Ic, If, Ig, Ih, Ii (depicted in Table I, lines 35-68 in Column 7 thereof, and Ij and Ik (depicted in Table I, lines 1-10 in Column 8 thereof). As noted above, preferably the alicyclic phosphonate esters are free of aromatic rings. It is also preferred that the alicyclic phosphonate esters have a phosphorus content of at least about 15 wt % and more preferably of at least about 20 wt %. The following compounds and mixtures thereof serve as non-limiting examples of particularly preferred alicyclic phosphonate esters:

### (5-ethyl-2-methyl-2-oxido-1,3,2-dioxaphosphinan-5-yl)methyl Methyl Methylphosphonate (a.k.a. Phosphonic Acid, Methyl-, (5-ethyl-2-methyl-2-oxido-1,3,2-dioxaphosphorinan-5-yl)methyl Methyl Ester; CAS No. 41203-81-0) of the Formula;

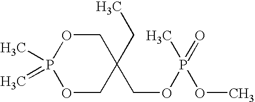

### bis[(5-ethyl-2-methyl-2-oxido-1,3,2-dioxaphosphinan-5-yl)methyl]methylphosphonate (a.k.a. Phosphonic Acid, Methyl-, bis[(5-ethyl-2-methyl-2-oxido-1,3,2-dioxaphosphorinan-5-yl)methyl]ester; CAS No. 42595-45-9) of the Formula;

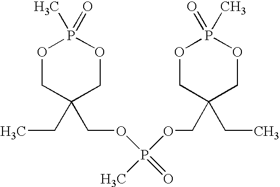

A flame retardant product, Antiblaze CU (Rhodia), containing about 65 wt % of the phosphonate of CAS No. 41203-81-0) and about 19 wt % of the phosphonate of CAS No. 42595-45-9) or similar products from other sources are illustrative of such mixtures.

### Substrate Polymers or Resins

Various polymers or resins can be flame retarded using the flame retardant combinations of A), B), and C) whether added, blended, or otherwise introduced into the polymer or resin as a preformed additive or individually and/or in one or more subcombinations. Thus polymers in general can benefit by use therein of flame retardant combinations of A), B), and C). Flame retardant combinations of A), B), and C) are particularly well suited for use in polyurethanes, including rigid polyurethanes, rigid polyurethane foams, flexible polyurethanes, flexible polyurethane foams, resilient polyurethane foams, flexible polyether polyurethane foams, flexible polyester polyurethane foams, and reaction injection molded polyurethanes. Other polymeric materials in which flame retardant combinations of A), B), and C) are well suited for use include epoxy resins, unsaturated polyester resins, and synthetic elastomers.

### Proportions

Typically components A), B), and C) are used in amounts such that on a weight basis:
(1) the proportions of A) to B) are in the range of about 0.25:1 to about 4:1; and preferably are in the range of about 0.5:1 to about 3:1; and
(2) the proportions of B) to C) are in the range of about 40:1 to about 3.5:1, and preferably are in the range of about 10:1 to about 3:1.

In use as flame retardants, the amounts of A), B), and C), proportioned as above, introduced into the polymer or resin, or into the formulation recipe used in forming the polymer such as a reaction injection molded polyurethane, will be a flame retardant amount, i.e., an amount typically in the range of about 2 to about 25 wt %, and preferably in the range of about 5 to about 15 wt %, based on the total weight of the polymer composition. More preferably, the amount of A), B), and C) used is an amount which confers sufficient flame retardancy to the resultant composition to enable the composition to satisfy most if not all qualification tests applicable to the particular polymer being flame retarded.

Flexible polyurethane foams of this invention will typically be formed using about 5-15 parts by weight of A), about 3-9 parts by weight of B), and about 0.2-2.5 parts by weight of C) per each 100 parts by weight of polyol used in forming the polyurethane foam. Preferred flexible polyurethane foams of this invention are formed using about 6-10 parts by weight of A), about 5-7 parts by weight of B), and about 0.5-2 parts by weight of C) per each 100 parts by weight of polyol used in forming the polyurethane foam. Preferably, these components are used in the form of a preformed liquid flame retardant additive composition of this invention as this simplifies the blending step and minimizes the possibility of blending errors. However, if desired, components A), B), and C) can be added individually and/or in one or more subcombinations to the mixture to be used in forming the polyurethane.

Departures from the above amounts and proportions whenever deemed necessary or desirable are permissible and within the scope of this invention.

### Other Components

Substances other than A), B), and C) can be included in the compositions of this invention as long as such optional components do not adversely affect the properties or performance of the compositions of this invention in any material way.

In the case of polyurethanes, a preferred component is at least one hindered amine antioxidant which preferably is a liquid. One type of liquid hindered amine antioxidant is a liquid alkylated diphenylamine in which the alkyl ring substituent or substituents each contain about 4-9 carbon atoms. One such product is Irganox® 5057 antioxidant (Ciba Specialty Chemicals, Inc.) which is a mixture N-phenylbenzeneamine (i.e., diphenylamine) reaction products with 2,4,4-trimethylpentene. A similar product is available from Great Lakes Chemical Corporation under the trade designation Durad® AX 57. Non-limiting examples of other suitable liquid hindered amine antioxidant components include Durad AX 55 (mixture of tertiary octylated and styrenated diphenylamine), Durad AX 59 (nonylated diphenylamine), and Irgastab® PUR 55 (Ciba Specialty Chemicals, Inc.) which is a mixture of diphenylamines with side chains on the phenyl ring having about 6-9 carbon atoms and hindered phenols with ester side chains having about 8-10 carbon atoms. Also suitable are hindered-amine antioxidants such as 4-benzoyloxy-2,2,6,6-tetramethylpiperidine, bis(2,2,6,6-tetramethyl-4-piperidinyl)sebacate, bis(1-octyloxy-2,2,6,6-tetramethyl-4-piperidinyl)sebacate, bis(1,2,2,6,6-pentamethyl-4-piperidinyl)sebacate, dimethyl succinate-1-(2-hydroxyethyl)4-hydroxy-2,2,6,6-tetramethylpiperidine and condensed products thereof, and 8-acetyl-3-dodecyl-7,7,9,9-tetramethyl-1,3,8-triazaspyrro[4,5]decane-2,4-dione. These may be used individually or in combinations with each other, or with other hindered amine antioxidants. Use of Irgastab® PUR 55 is preferred.

Still other components such as are used in forming polyurethane polymerization formulations or recipes are may be used in the compositions of this invention. Flexible polyurethane foams are typically prepared by chemical reaction between two liquids, isocyanates and polyols. The polyols are polyether or polyester polyols. The reaction readily occurs at room temperature in the presence of a blowing agent such as water, a volatile hydrocarbon, halocarbon, or halohydrocarbon, or mixtures of two or more such materials. Catalysts used in effecting the reaction include amine catalysts, tin-based catalysts, bismuth-based catalysts or other organometallic catalysts, and the like. Surfactants such as substituted silicone compounds are often used in order to maintain homogeneity of the cells in the polymerization system. Hindered phenolic antioxidants, e.g., 2,6-di-tert-butyl-para-cresol and methylenebis(2,6-di-tert-butylphenol), can be used to further assist in stabilization against oxidative degradation. These and other ingredients that can be used, and the proportions and manner in which they are used are reported in the literature. See for example: Herrington and Hock, Flexible Polyurethane Foams, The Dow Chemical Company, 1991, 9.25-9.27 or Roegler, M “Slabstock Foams”; in Polyurethane Handbook; Oertel, G., Ed.; Hanser Munich, 1985, 176-177 or Woods, G. Flexible Polyurethane Foams, Chemistry and Technology; Applied Science Publishers, London, 1982, 257-260.

In the practice of this invention in connection with polyurethanes, preferred polyols include Voranol® 3010 polyol, (The Dow Chemical Company, Midland, Mich.) and Pluracol® 1718 polyol (BASF Corporation, Mt. Olive, N.J.). Preferred isocyanates include Mondur TD-80, Mondur PF (Bayer Corporation, Pittsburgh, PHARMACEUTICALLY-ACCEPTABLE) and Luprinate T80 (BASF Corporation).

Preferred surfactants for polyurethanes include Niax® L-620 (OSi Specialties, Greenwich, Conn.), TEGOSTAB B 8229 (Goldschmidt Chemical Corporation, Hopewell, Va.) or any other of the many polyetherpolysilicone copolymers used in typical flexible polyurethane slabstock foams.

Preferred blowing agents for polyurethane foams include a combination of water and methylene chloride, Freon 11, or acetone, in a weight ratio in the range of about 1:2 to 2:1, respectively; with water and methylene chloride being the preferred combination.

Preferred catalyst systems for polyurethanes include a combination of a blend of amine catalysts such as a blend of (i) dimethylethyl amine, triethylene diamine, and bis(dimethylaminoethyl)ether) and (ii) DABCO® T-16 amine, in a weight ratio in the range of about 0.2-0.3:1, respectively; depending upon air flow and processing needs.

The literature is replete with detailed information about various types and forms of polyurethanes; and components, proportions and conditions used in preparing them. For example, one may refer to such references as Encyclopedia of Polymer Science and Technology, Volume 11, John Wiley & Sons, Copyright 1969, pages 506-563; Encyclopedia of Polymer Science and Technology, Volume 15, John Wiley & Sons, pages 445-479; Flexible Foams, Dow Polyurethanes, Second Edition, Ron Herrington and Kathy Hock, Editors, Copyright 1997 by The Dow Chemical Company; and U.S. Pat. Nos. 4,745,133; 5,104,910; 5,677,361; and 6,784,218.

The following Examples are presented for purposes of illustration, and are not intended to limit the generic scope of the invention.

Examples 1 and 2 illustrate the methods for preparing component A).

### EXAMPLE 1

### Reaction of Brominated Diester Diol with Acetic Anhydride

SAYTEX® RB-79 diol flame retardant (1900 g; a mixed ester of tetrabromophthalic anhydride with diethylene glycol and propylene glycol; Albemarle Corporation) was charged to a 2L reactor and heated to 120° C. Acetic anhydride (701 g, 6.87 mol) was then added with stirring over a 1 hour period. The mixture was cooked for 3 hours at 120-140° C. The mixture was vacuum stripped at 35 mm Hg and 130° C. with a slight N₂ purge for about 1 hour. A sample was taken for an acid number determination and the value was estimated to be about 3.1. Propylene oxide (25 g, 0.43 mol) was added to the mixture, which was then stirred for 30 minutes, after which time the acid number was found to be about 0.6. A further 27 g (0.46 mol) of propylene oxide were added, and the mixture was stirred for 1 hour at 130° C. The mixture was drained into glass bottles for analysis. The viscosity of the mixture was determined to be 1900 cP at 25° C. using glass capillary viscometers; the acid number was determined to be 0.64; and the amount of bromine in the mixture was 40.1 wt % (X-ray fluorescence).

### EXAMPLE 2

### Reaction of Brominated Diester Diol with Acetic Anhydride

A 1-L, 3-necked glass reactor equipped with a mechanical stirrer, a thermometer with a temperature regulator, a glycol-cooled (0° C.) reflux condenser, an addition funnel and a nitrogen flush assembly, was charged with SAYTEX® RB-79 diol flame retardant (556 g, 0.885 mol; heated to 75° C. prior to addition to allow good flow) and stirred at 75° C. under nitrogen. The addition funnel was charged with acetic anhydride (180.5 g, 1.77 mol), which was then added drop-wise to the diol during 20 minutes. A small (8°) exotherm was noticed during the addition which allowed the reaction temperature to rise to 83° C. The reaction mixture lightened in color at this point. The contents were heated to 95° C. and stirred at that temperature under nitrogen for the next four hours. The equipment was now set for distillation by installing a Barrett trap and the reaction temperature was raised to 130° C. to distill acetic acid by-product. The reaction mixture was then poured into a round-bottom flask and concentrated at the rotary evaporator at 95° C. (4-5 torr) for 45 minutes to give 629 g (0.883 mole, 99.8%) of the product as a pale yellow liquid. The acid number of this product was determined to be 4.5.1. The product was re-heated and transferred back to the reactor and then 300 mL of toluene and 200 mL of water were added. The material dissolved in toluene and formed the bottom, organic layer. The phases were heated and stirred at 45° C. for 15 minutes, then the phases were allowed to separate. The pH of aqueous layer was measured to be equal to 4. While stirring at 45° C., aqueous caustic (50%) was added until the pH of the aqueous layer was about 8. The phases were allowed to separate and then the lower, organic phase was removed and concentrated under reduced pressure (rotary evaporator, 3-4 torr) at 90° C. for one hour to give 579.6 g (0.814 mole, 92.5%) of the product as a pale yellow liquid. The acid number was determined to be 0.14 and FT-IR spectra were recorded which confirmed the ester formation and total absence of the hydroxyl groups of the starting material. The TGA indicated the following weight loss profile: 5% loss at 162.6° C., 10% loss at 194.4° C., 50% loss at 339.7° C.

### EXAMPLES 3-6

A group of tests were conducted using a polyurethane formulation used for screening flame retardant effectiveness. The components used in these test are as follows:
Component A)-Mixed ester of tetrabromophthalic anhydride with diethylene glycol and propylene glycol acylated with acetic anhydride (note Examples 1 and 2);
Component B)-Isopropylated phenyl phosphate having a phosphorus content of 8.3 wt % (Antiblaze® 519 flame retardant; Albemarle Corporation)
Component C)— a mixture of phosphonic acid, methyl-, (5-ethyl-2-methyl-2-oxido-1,3,2-dioxaphosphorinan-5-yl)methyl methyl ester and phosphonic acid, methyl-, bis[(5-ethyl-2-methyl-2-oxido-1,3,2-dioxaphosphorinan-5-yl)methyl]ester (Mixture of CAS 41203-81-0 and CAS 42595-45-9) (Amgard CU; Rhodia);
Component D)-Irgastab® PUR 55 (Ciba Specialty Chemicals, Inc.) which is a mixture of diphenylamines with side chains on the phenyl ring having about 6-9 carbon atoms and hindered phenols with ester side chains having about 8-10 carbon atoms.
   The results of the California 117 Test Procedure (“Cal 117”) are summarized in the Table. The Cal 117 results on a composition in which components A) and B) without C) (“Comp. Ex. A”) were used and subjected to the same test procedure are also shown in the Table.

TABLE

| Components | Ex. 3 | Ex. 4 | Ex. 5 | Ex. 6 | Comp. Ex. A |
|---|---|---|---|---|---|
| A) | 57 | 57 | 57 | 61 | 56.88 wt % |
| B) | 37 | 35 | 33 | 33 | 42.22 wt % |
| C) | 5 | 7 | 9 | 5 | none |
| D) | 1 | 1 | 1 | 1 | 0.9 wt % |
| Total Br % | 25 | 25 | 25 | 27.2 | 25 |
| Tota P % | 4.1 | 4.4 | 4.7 | 4.1 | 3.5 |
| Viscosity @25° C., | 2125 | 2900 | 3425 | 3100 | ca. 900 |
| cPs | | | | | |
| Results | Pass | Pass | Pass | Pass | Fail |
| Cal 117, unaged, in. | 3.2 | 3.7 | 3.1 | 2.9 | 12 |
| Cal 117, unaged, | 0 | 3.5 | 2.7 | 0.8 | N/A |
| sec. | | | | | |
| Cal 117, aged, in. | 3.3 | 3.3 | 3.1 | 3.0 | — |
| Cal 117, aged, sec. | 1.8 | 3.1 | 2.0 | 0.8 | — |

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what preliminary chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with the application of common sense and the ordinary skill of a chemist, is thus immaterial.

Each and every patent or publication referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

1. A flame retardant additive composition comprising a liquid mixture formed from at least the following components:
A) at least one bis(alkanoic acid ester) of a ring-brominated aromatic diester diol;
B) alkylated triphenyl phosphate having an approximate average formula (RₓPhO)₃P═O) in which each R is, independently, a hydrogen atom or an alkyl group having in the range of 1 to 4 carbon atoms and x is an average number in the range of about 0.2 to 3; and
C) at least one alicyclic phosphonate ester having 1, 2 or 3 phosphorus atoms in the molecule, at least one of which is part of an alicyclic ring system, and having a phosphorus content of at least about 15 wt %.

2. A composition as in claim 1 wherein A) is a bis(alkanoic acid ester) of a mixed ester of at least one bromophthalic anhydride having at least two bromine on the aromatic ring with diethylene glycol and propylene glycol.

3. A composition as in claim 1 wherein A) is a bis(alkanoic acid ester) of a mixed ester of tetrabromophthalic anhydride with diethylene glycol and propylene glycol.

4. A composition as in claim 3 wherein the bis(alkanoic acid ester) of a mixed ester of tetrabromophthalic anhydride with diethylene glycol and propylene glycol is the bis(ethanoic acid ester) of said mixed ester.

5. A composition as in claim 1 wherein R of the formula in B) is isopropyl.

6. A composition as in claim 1 wherein x in said formula is an average number between about 0.8 and about 1.2.

7. A composition as in claim 1 wherein the phosphorus content of C) is at least about 20 wt %.

8. A composition as in claim 1 wherein C) is a mixture comprising (i) phosphonic acid, methyl-, (5-ethyl-2-methyl-2-oxido-1,3,2-dioxaphosphorinan-5-yl)methyl methyl ester and (ii) phosphonic acid, methyl-, bis[(5-ethyl-2-methyl-2-oxido-1,3,2-dioxaphosphorinan-5-yl)methyl]ester.

9. A composition as in claim 1 wherein A) is a bis(alkanoic acid ester) of a mixed ester of at least one bromophthalic anhydride having at least two bromine on the aromatic ring with diethylene glycol and propylene glycol; wherein R of the formula in B) is isopropyl; and wherein C) comprises phosphonic acid, methyl-, (5-ethyl-2-methyl-2-oxido-1,3,2-dioxaphosphorinan-5-yl)methyl methyl ester.

10. A composition as in claim 9 wherein A) has 4 bromine atoms on the aromatic ring, wherein x of the formula in B) is an average number between about 0.8 and about 1.2, and wherein C) further comprises phosphonic acid, methyl-, bis[(5-ethyl-2-methyl-2-oxido-1,3,2-dioxaphosphorinan-5-yl)methyl]ester.

11. A composition as in claim 9 wherein said composition further comprises a liquid alkylated diphenylamine in which the alkyl ring substituent or substituents each contain about 4-9 carbon atoms.

12. A composition as in claim 9 wherein said composition further comprises a mixture of diphenylamines with side chains on the phenyl ring having about 6-9 carbon atoms and hindered phenols with ester side chains having about 8-10 carbon atoms.

13. A composition as in claim 9 wherein A) is the bis(ethanoic acid ester) of a mixed ester of tetrabromophthalic anhydride with diethylene glycol and propylene glycol.

14. A flame retardant composition formed from components comprising a polymer or resin selected from polyurethanes, epoxy resins, unsaturated polyester resins, and synthetic elastomers; A) at least one bis(alkanoic acid ester) of a ring-brominated aromatic diester diol; B) alkylated triphenyl phosphate having an approximate average formula (RₓPhO)₃P═O) in which each R is, independently, a hydrogen atom or an alkyl group having in the range of 1 to 4 carbon atoms and x is an average number in the range of about 0.2 to 3; and C) at least one alicyclic phosphonate ester having 1, 2 or 3 phosphorus atoms in the molecule, at least one of which is part of an alicyclic ring system, and having a phosphorus content of at least about 15 wt %, components A), B), and C) being introduced in the form of an additive mixture or individually and/or in one or more subcombinations into said polymer or resin or the precursor formulation or recipe used in forming said composition.

15. A composition as in claim 14 wherein the polymer or resin of said composition is a polyurethane and A), B), and C) are introduced in the form of an additive mixture or individually and/or in one or more subcombinations into the precursor formulation or recipe used in forming said composition.

16. A composition as in claim 15 wherein said polyurethane is selected from rigid polyurethanes, rigid polyurethane foams, flexible polyurethanes, flexible polyurethane foams, resilient polyurethane foams, flexible polyether polyurethane foams, flexible polyester polyurethane foams, and reaction injection molded polyurethanes.

17. A composition as in claim 14 wherein said composition is a flame retardant flexible polyurethane composition formed from components comprising isocyanate, polyol, surfactant, and catalyst.

18. A composition as in claim 17 wherein A) is a bis(alkanoic acid ester) of a mixed ester of at least one bromophthalic anhydride having at least two bromine on the aromatic ring with diethylene glycol and propylene glycol; wherein x in said formula is an average number between about 0.8 and about 1.2; and wherein C) is present in said composition and comprises a liquid alkylated diphenylamine in which the alkyl ring substituent or substituents each contain about 4-9 carbon atoms.

19. A composition as in claim 17 wherein A) is a bis(alkanoic acid ester) of a mixed ester of at least one bromophthalic anhydride having at least two bromine on the aromatic ring with diethylene glycol and propylene glycol; wherein R in said formula is isopropyl; and wherein C) is present in said composition and comprises a liquid alkylated diphenylamine in which the alkyl ring substituent or substituents each contain about 4-9 carbon atoms.

20. A composition as in claim 17 wherein A) is the bis(ethanoic acid ester) of a mixed ester of tetrabromophthalic anhydride with diethylene glycol and propylene glycol; wherein R in said formula is isopropyl and wherein x in said formula is an average number between about 0.8 and about 1.2; and C) is present in said composition is a mixture of diphenylamines with side chains on the phenyl ring having about 6-9 carbon atoms and hindered phenols with ester side chains having about 8-10 carbon atoms.

21. A composition as claim 17 wherein the flame retardant flexible polyurethane composition is in the form of a foam.

22. A composition as in claim 21 wherein the foam can pass the California 117 Test Procedure as set forth in Technical Bulletin 117 dated March 2000.

23. A method of producing a flexible polyurethane composition from components comprising isocyanate, polyol, surfactant, and catalyst, which method further comprises including in the polymerization formulation or recipe:
A) at least one bis(alkanoic acid ester) of a ring-brominated aromatic diester diol;
B) alkylated triphenyl phosphate having an approximate average formula (RₓPhO)₃P═O) in which each R is, independently, a hydrogen atom or an alkyl group having in the range of 1 to 4 carbon atoms and x is an average number in the range of about 1 to about 2; and
C) at least one alicyclic phosphonate ester having 1, 2 or 3 phosphorus atoms in the molecule, at least one of which is part of an alicyclic ring system, and having a phosphorus content of at least about 15 wt %
so that a flame retardant flexible polyurethane is produced.

24. A method as in claim 23 wherein A) is a bis(alkanoic acid ester) of a mixed ester of tetrabromophthalic anhydride with diethylene glycol and propylene glycol; wherein x in the formula in B) is an average number between about 0.8 and about 1.2;
and wherein C) is a mixture comprising (i) phosphonic acid, methyl-, (5-ethyl-2-methyl-2-oxido-1,3,2-dioxaphosphorinan-5-yl)methyl methyl ester and (ii) phosphonic acid, methyl-, bis[(5-ethyl-2-methyl-2-oxido-1,3,2-dioxaphosphorinan-5-yl)methyl]ester.

25. A method as in claim 24 wherein said components further comprise a liquid alkylated diphenylamine in which the alkyl ring substituent or substituents each contain about 4-9 carbon atoms.

26. A method as in claim 24 wherein said components further comprise a mixture of diphenylamines with side chains on the phenyl ring having about 6-9 carbon atoms and hindered phenols with ester side chains having about 8-10 carbon atoms.

27. A method as in claim 23 wherein the components of the flexible polyurethane composition include at least one blowing agent so that the flame retardant flexible polyurethane produced is in the form of a foam.
